(19) United States
(12) Patent Application Publication
(10) Pub. No.: US 2007/0263949 A1
(43) Pub. Date: Nov. 15, 2007

(54) Supporting structure for a slide assembly

(76) Inventors: Ken-Ching Chen, Lu-Chu Hsiang (TW); Wei-Sheng Wang, Lu-Chu Hsiang (TW); Chun-Chiang Wang, Lu-Chu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/433,441

(22) Filed: May 15, 2006

(51) Int. Cl. F16C 29/06

(52) U.S. Cl. 384/45

(57) ABSTRACT

A supporting structure for a slide assembly is applied to combination of a slide assembly and a foldable cable management arm. The slide assembly includes inner and outer rails. The inner rail slides in the outer rail. The inner rail contains a ball bearing disposed close to a terminal end of the inner rail. The ball bearing includes upper and lower ball channels and a plurality of balls. The inner rail may be directly disposed with the upper and the lower ball channels and the balls. Each of the upper and the lower ball channels is disposed with an open section relatively to the outer rail. The balls are contained in both the upper and the lower ball channels and roll around the open sections of the upper and the lower ball channels to relatively support the outer rail.

### BACKGROUND OF THE INVENTION

(a) Field of the Invention

The present invention relates to a supporting structure for a slide assembly, and more particularly, to one that is applicable to be incorporated to a slide assembly of a foldable cable management arm and contains an inner rail disposed with a ball bearing to support the terminal of the inner rail all way through the sliding by the inner rail in relation to an outer rail.

(b) Description of the Prior Art

In the design of a slide assembly, particularly for one to be incorporated with a foldable cable management arm, there is the absence of a support to where between the terminal of an inner rail and an outer rail due to that balls usually fail to reach there when the inner rail in relation to the outer rail operates on the balls as slide media. The terminal of the inner rail is often caught in suspension status when the inner rail is fully retracted into the outer rail; accordingly, the suspended terminal is vulnerable to be twisted. Accordingly, when a brace at the front of a cable management arm is linked to the terminal of the inner rail, insufficient support is delivered to the inner rail at where linked to the brace that results in serious drooping to the cable management arm.

Referring to FIG. 10 of the accompanying drawings, when an inner rail (A) of a slide assembly is fully retracted into an outer rail (B), there is the absence of any ball (C) to support the area between the terminal of the inner rail (A) and the outer rail (B) to leave the terminal of the inner rail (A) without support from the ball (C) becoming a suspended rail (A1). When the slide assembly is mounted to a cable management arm (D), a brace at the front of the cable management arm is connected to the suspended rail (A1) so that the retracted cable management arm (D) indicates a state of a “cantilever” status in relation to the inner rail (A). Therefore, the central gravity of the cable management arm (D) plus that of the cable (not illustrated) would have to pull the suspended rail (A1) of the inner rail (A) to twist the suspended rail (A1) thus to compromise a firm support at the support where the cable management arm (D) is connected to the inner rail (A) to cause the cable management arm (D) to droop and incline. If the cable management arm (D) connected to the slide is composed of an upper and a lower arms (D), the cable management arm (D) on top when droops will interfere with a drawer or similar object incorporated to the slide assembly or the lower cable management arm (D) to affect the normal pull and push operation of the lower cable management arm (D) or the drawer or similar object.

### SUMMARY OF THE INVENTION

The primary purpose of the present invention is to provide a supporting structure for a slide assembly, particularly adapted to a slide assembly incorporated to a foldable cable management arm to support an inner rail all way through relative sliding by an outer rail while correcting the problem of insufficient support by a slide support of the prior art when the inner rail is fully retracted to the outer rail.

According to the present invention, there is provided a supporting structure for a slide assembly, the slide assembly comprises an inner rail and an outer rail with the former sliding in the outer rail. A ball bearing disposed to the inner rail includes an upper ball channel, a lower ball channel, and a plurality of balls. Or, alternatively the upper ball channel, the lower ball channel and the balls are directly disposed to the inner rail. Each of the upper and the lower ball channels is a circulation ball channel and contains an open section corresponding to the outer rail. The balls are contained in both the upper and the lower ball channels, and the balls relatively support the outer rail at the open sections of the upper and the lower ball channels.

Preferably the ball bearing is disposed near a terminal end of the inner rail, or the inner rail is directly provided with the upper and the lower ball channels and the balls near the terminal end of the inner rail.

Accordingly, by referring to the prior art, the inner rail of the present invention when fully retracted or sliding in relation to the outer rail is also capable of being supported by the outer rail to provide more steady and safer support for the slide assembly.

### BRIEF DESCRIPTION OF THE DRAWINGS

FIG. 1 is a perspective view of a first preferred embodiment of the present invention.

FIG. 2 is an exploded view of a primary construction of the first preferred embodiment of the present invention.

FIG. 3 is a sectional view showing the first preferred embodiment of the present invention as assembled.

FIG. 4 is a schematic view showing retraction of a slide assembly connected to a cable management arm in the first preferred embodiment of the present invention.

FIG. 5 is a schematic view showing a local pull and extension of the slide assembly connected to the cable management arm in the first preferred embodiment of the present invention.

FIG. 6 is an exploded view of a primary construction of a second preferred embodiment of the present invention.

FIG. 7 is a perspective view of the second preferred embodiment of the present invention as assembled.

FIG. 8 is an exploded view of a third preferred embodiment of the present invention.

FIG. 9 is a perspective view of a primary construction of a fourth preferred embodiment of the present invention.

FIG. 10 is a perspective view of the prior art.

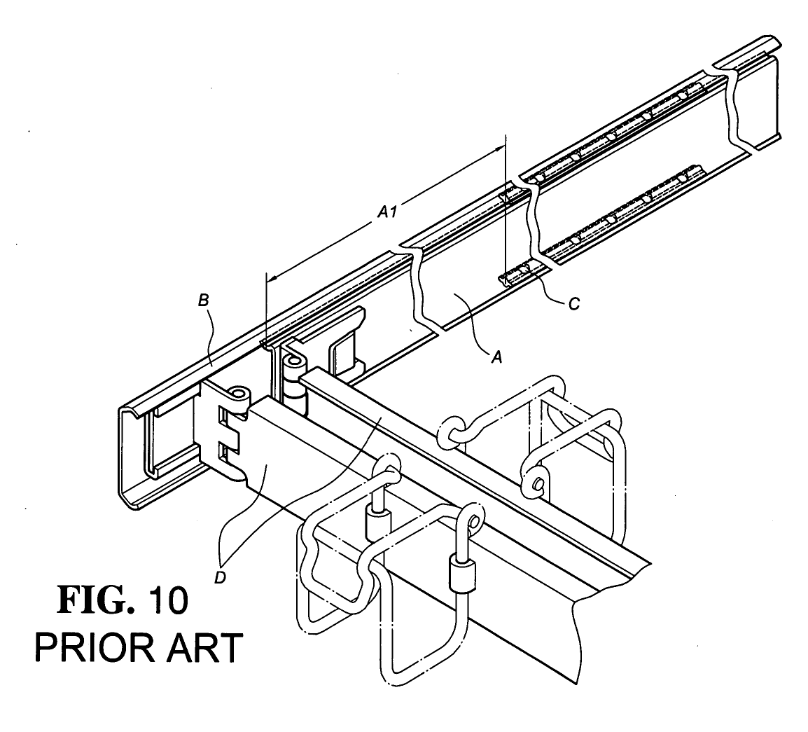

### DETAILED DESCRIPTION OF THE PREFERRED EMBODIMENTS

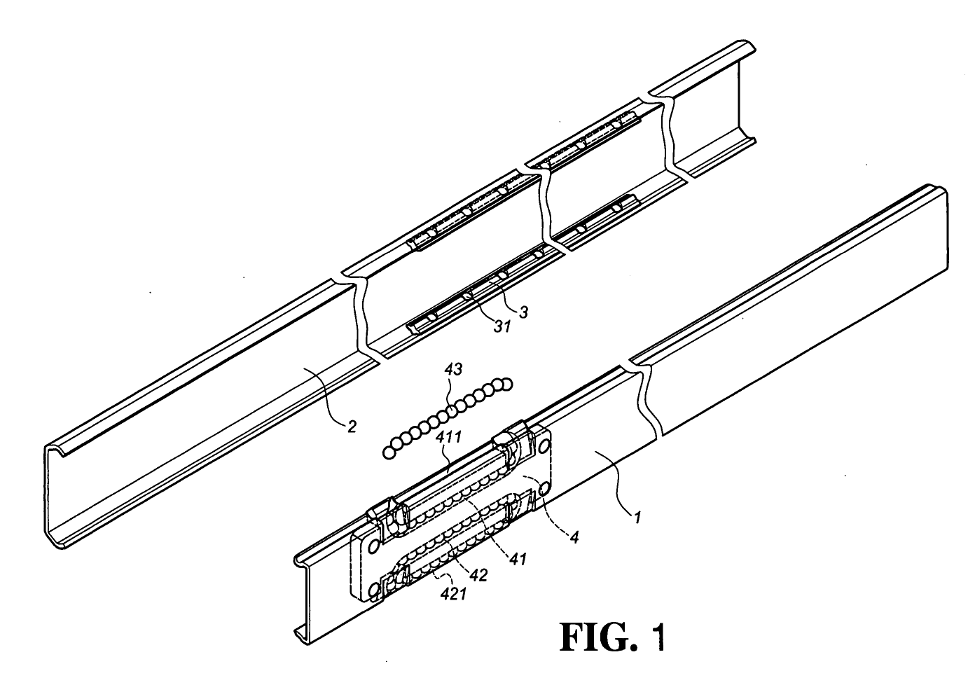

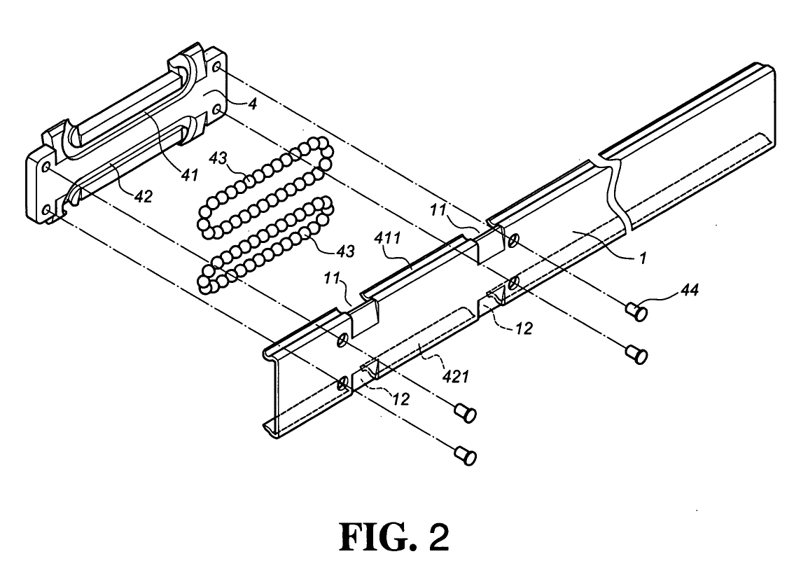

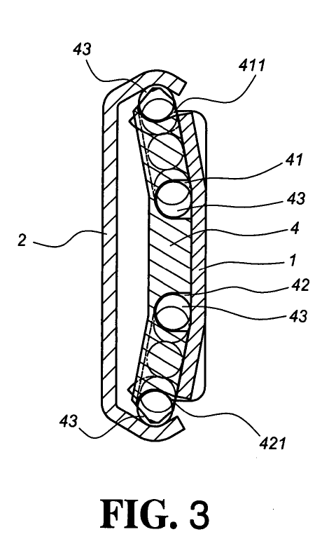

Referring to FIGS. 1, 2, and 3, a first preferred embodiment of the present invention comprises a two-section slide containing an inner rail (1) and an outer rail (2) with the inner rail (1) sliding in the outer rail (2) by means of multiple inner balls (31) and an inner ball carrier (3).

The inner rail (1) is disposed with a ball bearing (4) near a terminal end of the inner rail (1). The ball bearing (4) is a wide and flat member including an upper ball channel (41), a lower ball channel (42) and multiple balls (43). Both the upper and the lower ball channels (41, 42) are circulation ball channels each with a circular route, and respectively contain an open section (411, 421) in relation to the outer rail (2). In the first preferred embodiment of the present invention, each of the open sections (411, 421) is a section of a ball slot of the inner rail (1) near the terminal end of the inner rail (1). Both ends of the ball slot of the inner rail (1) are respectively disposed with gaps (11, 12) corresponding to the outlets of both the upper and the lower ball channels (41, 42) so as to indicate loop distribution within both the upper and the lower ball channels (41, 42) to accommodate the multiple balls (43). The multiple balls (43) roll around in the open sections (411, 421) of the upper and the lower ball channels (41, 42) to relatively support the outer rail (2). Furthermore, the ball bearing (4) is fixed to the inner rail (1) by means of fastening members (44).

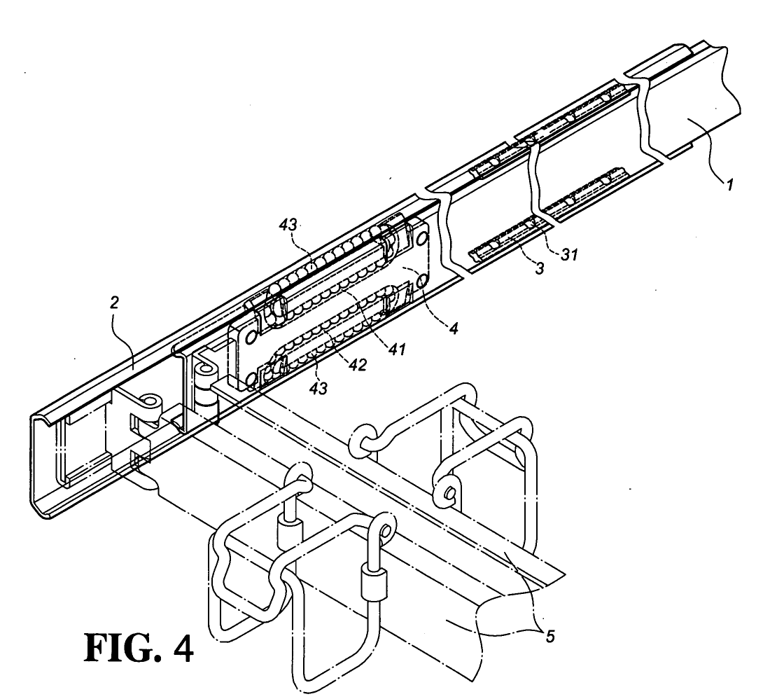

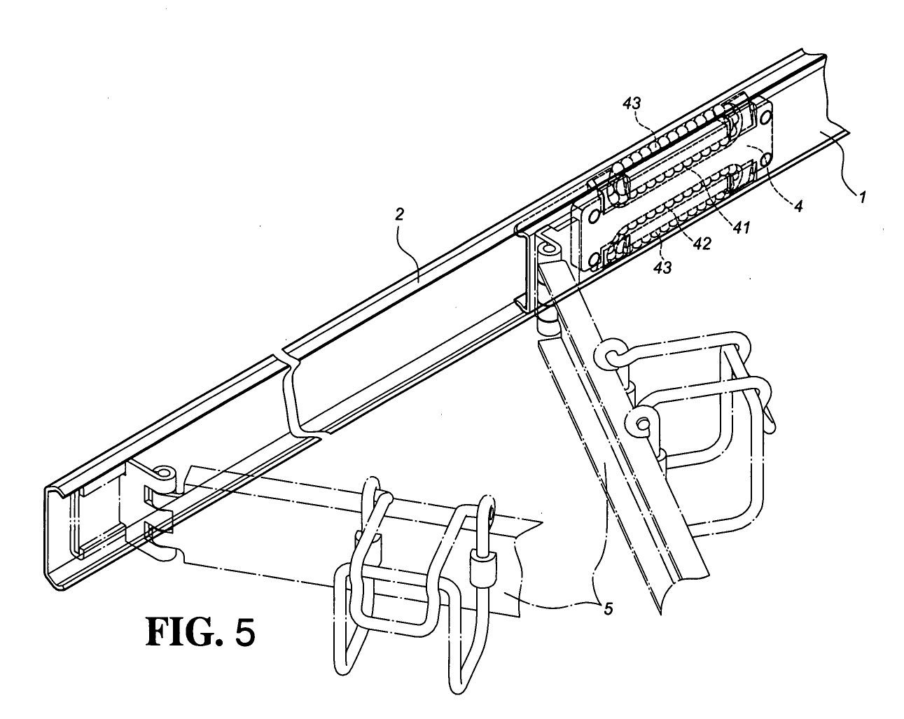

Now referring to FIGS. 4 and 5 for a schematic view showing that the first preferred embodiment of the present invention is connected to a cable management arm (5), the inner rail (1) is supported to the outer rail (2) by means of the multiple balls (43) contained in the upper and the lower ball channels (41, 42). The inner rail (1) remains to be supported by the outer rail (2) thus to prevent the cable management arm (5) from dropping since the terminal end of the inner rail (1) is connected to the cable management arm (5) whether the slide assembly is fully retracted or sliding.

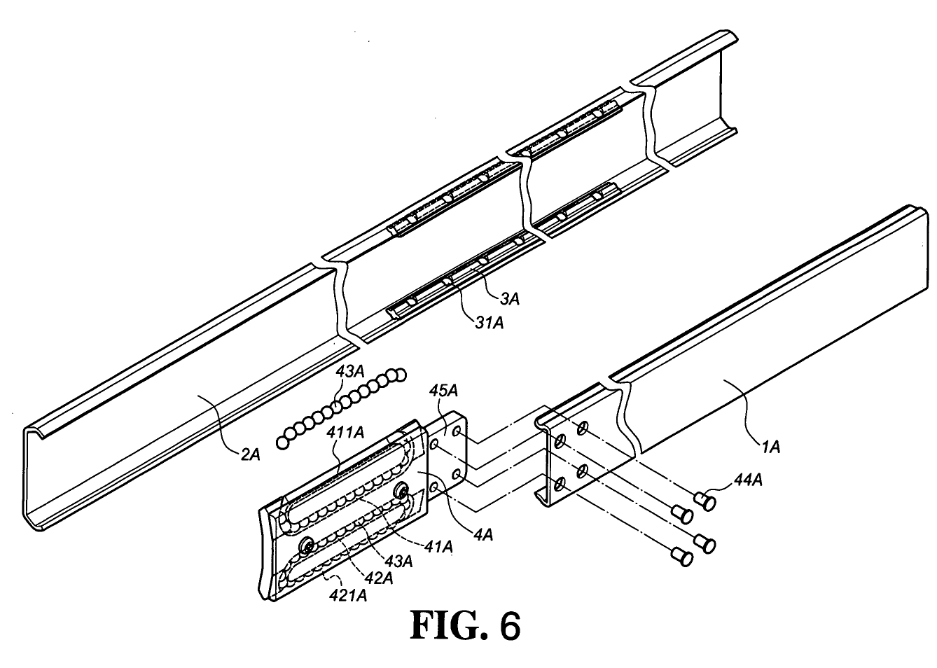

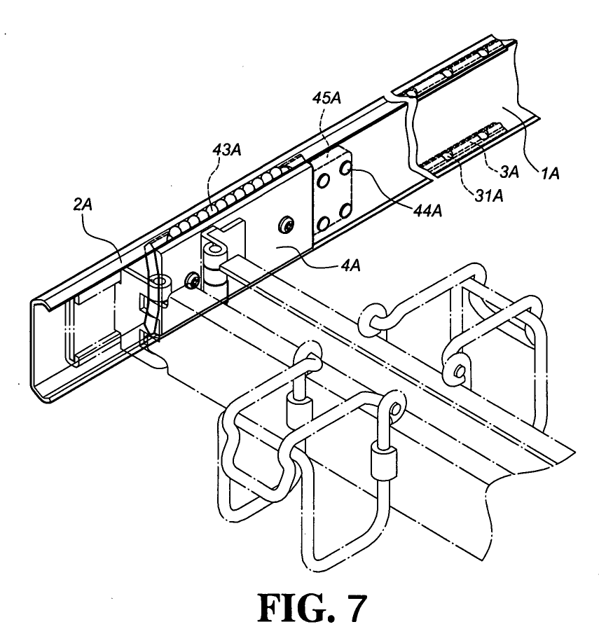

As illustrated in FIGS. 6 and 7, a second preferred embodiment of the present invention comprises a two-section slide containing an inner rail (1A) and an outer rail (2A) with the inner rail (1A) sliding in the outer rail (2A) by means of multiple inner balls (31A) and an inner ball carrier (3A).

The inner rail (1A) at its terminal is connected to a ball bearing (4A). The ball bearing (4A) includes an upper ball channel (41A), a lower ball channel (42A), multiple balls (43A), and a connection portion (45A). Each of both the upper and the lower ball channels (41A, 42A) is equipped with a circulation ball channel containing circular route and an open section (411A, 421A) corresponding to the outer rail (2A) so as to indicate circular distribution in both the upper and the lower ball channels (41A, 42A) to accommodate the balls (43A). The multiple balls (43A) roll around in the open sections (411A, 421A) of the upper and the lower ball channels (41A, 42A) to relatively support the outer rail (2A). Furthermore, the connection portion (45A) of the ball bearing (4A) is fixed to the terminal of the inner rail (1A) by means of fastening members (44A).

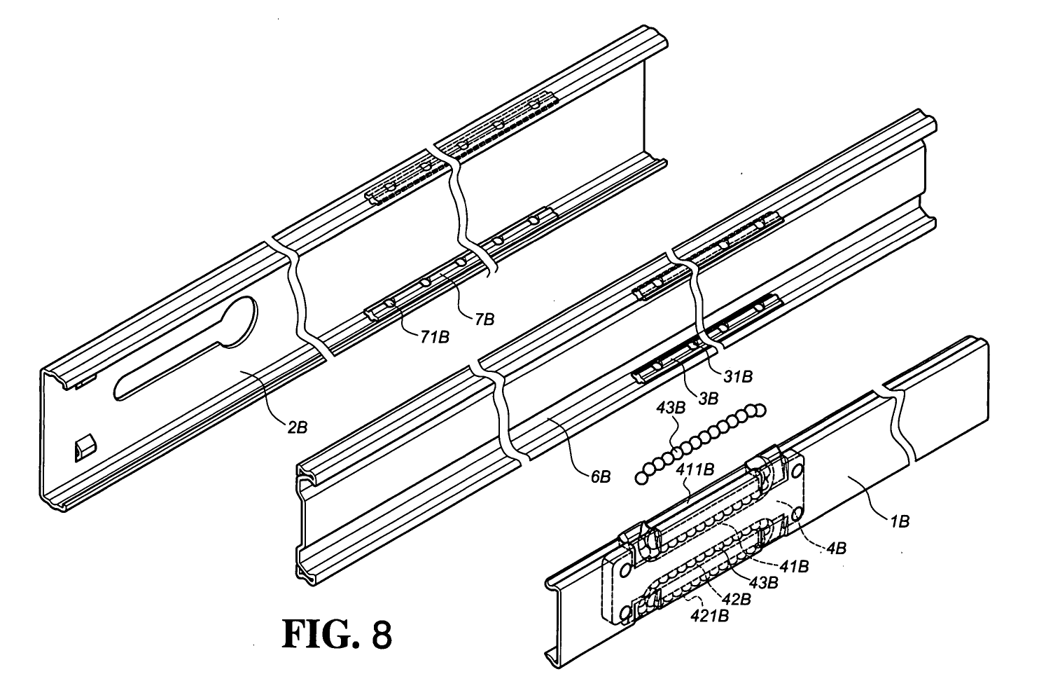

While a two-section slide containing an inner rail and an outer rail is applied for describing the first and second preferred embodiments of the present invention; a third preferred embodiment of the present invention is also applicable to a three-section slide including an inner rail, a middle rail and an outer rail as illustrated in FIG. 8. Wherein, an inner rail (1B) slides in a middle rail (6B) by mans of multiple inner balls (31B) and an inner ball carrier (3B); and the middle rail (6B) slides in the outer rail (2B) by means of multiple outer balls (71B) and an outer ball carrier (7B).

The inner rail (1B) is provided with a ball bearing (4B), and the ball bearing (4B) includes an upper ball channel (41B), a lower ball channel (42B), and multiple balls (43B). Each of the upper and the lower ball channels (41B, 42B) contains a circular route circulation ball channel, and is disposed with an open section (411B, 421B) in relation to the middle rail (6B) so as to indicate circular distribution in the upper and the lower ball channels (41B, 42B) to accommodate the multiple balls (43B). The multiple balls (43B) roll in circle on the open sections (411B, 421B) of the upper and the lower ball channels (41B, 42B) to relatively support the middle rail (6B).

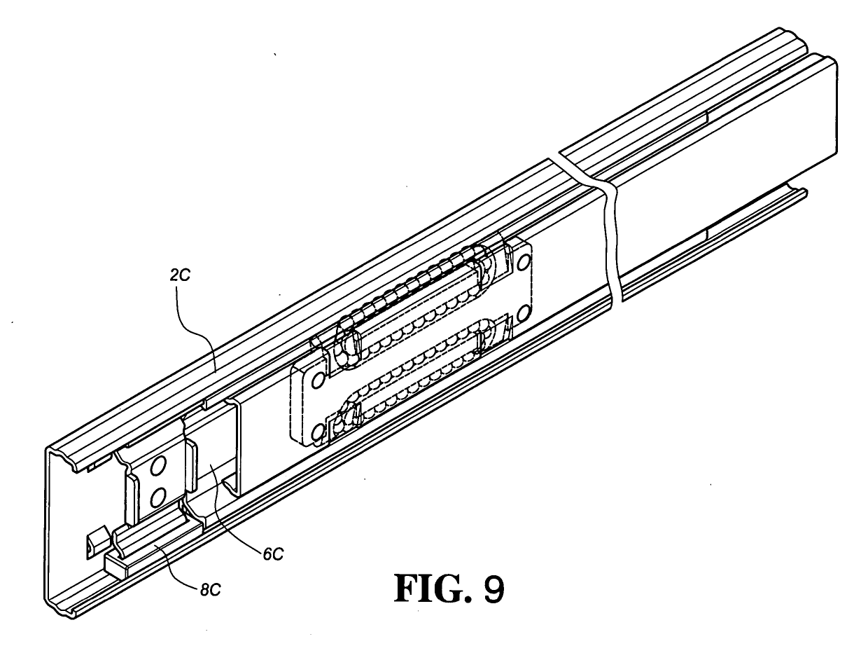

Furthermore, a fourth preferred embodiment of the present invention as illustrated in FIG. 9, a support base (8C) is disposed to the terminal of a middle rail (6C) for the middle rail (6C) to extend into an outer rail (2C) by means of the support base (8C).

What is claimed is:

1. A supporting structure for a slide assembly, the slide assembly comprising an inner rail and an outer rail; the inner rail sliding in the outer rail; and characterized by:
the inner rail being provided with a ball bearing; the ball bearing including an upper ball channel, a lower ball channel and a plurality of balls; each of the upper and the lower ball channels being a circulation ball channel; each of the upper and the lower ball channels including an open section in relation to the outer rail; the balls being contained in both the upper and the lower ball channels; and the balls rolling around the open sections of the upper and the lower ball channels to relatively support the outer rail.

2. The supporting structure for a slide assembly of claim 1, wherein the ball bearing is disposed near a terminal end of the inner rail.

3. The supporting structure for a slide assembly of claim 1, wherein each of the open sections of the upper and the lower ball channels is a section of a ball slot of the inner rail near the terminal end of the inner rail; and both ends of the ball slot of the inner rail are respectively disposed with a gap in relation to each outlet of the upper and the lower ball channels.

4. A supporting structure for a slide assembly, the slide assembly comprising an inner rail and an outer rail; the inner rail sliding in the outer rail; and characterized by:
a terminal end of the inner rail being connected to a ball bearing; the ball bearing including an upper ball channel, a lower ball channel, a plurality of balls and a connection portion; each of the upper and the lower ball channels being a circulation channel and containing an open section respectively in relation to the outer rail; the balls being contained in both the upper and the lower ball channels; and
the balls rolling around the open sections of the upper and the lower ball channels to relatively support the outer rail.

5. A supporting structure for a slide assembly, the slide assembly comprising an inner rail, a middle rail, and an outer rail; the inner rail sliding in the middle rail; the middle rail sliding in the outer rail; and characterized by:
the inner rail being disposed with a ball bearing; the ball bearing including an upper ball channel, a lower ball channel, and a plurality of balls; each of the upper and the lower ball channels being a circulation ball channel; each of the upper and the lower ball channels being disposed with an open section in relation to the middle rail; the balls being contained in both the upper and the lower ball channels; and the balls rolling around the open sections of the upper and the lower ball channels to relatively support the middle rail.

6. The supporting structure for a slide assembly of claim 5, wherein a support base is disposed to a terminal end of the middle rail and the support base extends into the outer rail.
